(19) United States
(12) Patent Application Publication
(10) Pub. No.: US 2006/0213110 A1
(43) Pub. Date: Sep. 28, 2006

(54) Natural bait containment vehicle

(76) Inventors: Pheaktra Nhou, Ontario, CA (US); Everardo R. Cabral, Hacienda Heights, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/089,252

(22) Filed: Mar. 23, 2005

(51) Int. Cl. A01K 83/06; A01K 85/01

(52) U.S. Cl. 43/41; 43/42.06; 43/44.2; 43/44.8

(57) ABSTRACT

A cage engages a fishing bait. The cage is formed of a dried and compressed plant matter fabric of a thickness not greater than approximately 0.060. The plant matter fabric provides a portion having plural perforations, wherein the perforations comprise at least 50% of a surface area of the first portion. The cage forms an open first end for passing the fishing bait into the cage. A fishing hook is pressed through the cage and bait to hold these two elements securely while fishing.

### RELATED APPLICATIONS

None

### BACKGROUND OF THE INVENTION

1. Field of the Invention

This disclosure relates to fishing bait containment devices for securing baits to fishing hooks, and more particularly to a bait containment cage made of natural plant materials which is capable of supporting a fragile bait during fishing activities.

2. Description of Related Art

The following art defines the present state of this field:

Lang, U.S. Pat. No. 3,769,740, discloses a chum dispensing device having a buoyant chum holder and a dispenser on a leader line which optionally has a connector on its free end. A preferred embodiment comprises the buoyant chum dispenser in combination with a carrier sinker.

Levey, U.S. Pat. No. 5,617,669, discloses a container comprising a pair of longitudinally divided cylinder halves molded unitarily with a connecting “living hinge” running the entire length of the container. Mating fasteners are provided on the ends of the halves opposite the hinge. Weight-receiving pockets are molded integrally with the ends of the lower half.

Our prior art search with abstracts described above teaches a chum dispensing device and a chum distributor, both of which provide an enclosure for holding the chum. However, the prior art fails to disclose a chum or bait enclosure fabricated from a natural water borne fabric material. The prior art fails to teach such an enclosure with adequate openings to expose significant enclosed bait to target fish. The present invention fulfills these needs and provides further related advantages as described in the following summary.

### SUMMARY OF THE INVENTION

The present invention teaches certain benefits in construction and use which give rise to the objectives described below.

In the sport and practice of fishing, whether fresh water or salt water, deep-sea or fly fishing, certain fishing baits are delicate or may degrade due to water immersion or mechanical strains inherent in this type of activity. In this case one seeks a means for improved securement of the bait to a fishing hook or fishing lure. The prior art is directed to certain solutions. However, prior art solutions may be time consuming and inconvenient, such as tying a bait to a fishing hook; or may reduce fishing efficacy, such as using a bait holder that is not made of a natural material.

The present embodiment provides a solution to this problem. In one embodiment a cage engages a fishing bait. The cage is formed of a dried and compressed plant matter fabric of a thickness not greater than approximately 0.060 inches. The plant matter fabric provides a portion having plural perforations, wherein the perforations comprise at least 50% of a surface area of the fabric. The cage forms an open first end for passing the fishing bait into the cage and an opposing hole that allows a part of the bait to extend free of the cage.

A primary objective of the embodiments is to provide an apparatus and method of use of such apparatus that yields advantages not taught by the prior art.

Another objective of the embodiments is to provide a fishing bait containing apparatus capable of securing a delicate or flimsy fishing bait in such a manner as to assure that the bait does not beak up during casting, reeling and re-casting, and other vigorous fishing activities.

A further objective of the embodiments is to provide a bait securing apparatus capable of being recognized by marine life as a natural water-borne material.

A still further objective of the embodiments is to provide a bait securing apparatus capable of being formed of natural materials using simple fabrication steps into a strong and relatively durable bait cage.

A still further objective of the embodiments is to provide a bait securing cage capable of having a fishing hook penetration at arbitrary locations without deleterious effects to the structure and integrity of the cage.

Other features and advantages of the embodiments will become apparent from the following more detailed description, taken in conjunction with the accompanying drawings, which illustrate, by way of example, the principles of at least one of the possible embodiments.

### BRIEF DESCRIPTION OF THE DRAWINGS

The accompanying drawings illustrate at least one of the best mode embodiments of the present invention. In such drawings:

FIGS. 1 and 2 are perspective views of one embodiment of the present disclosure; and

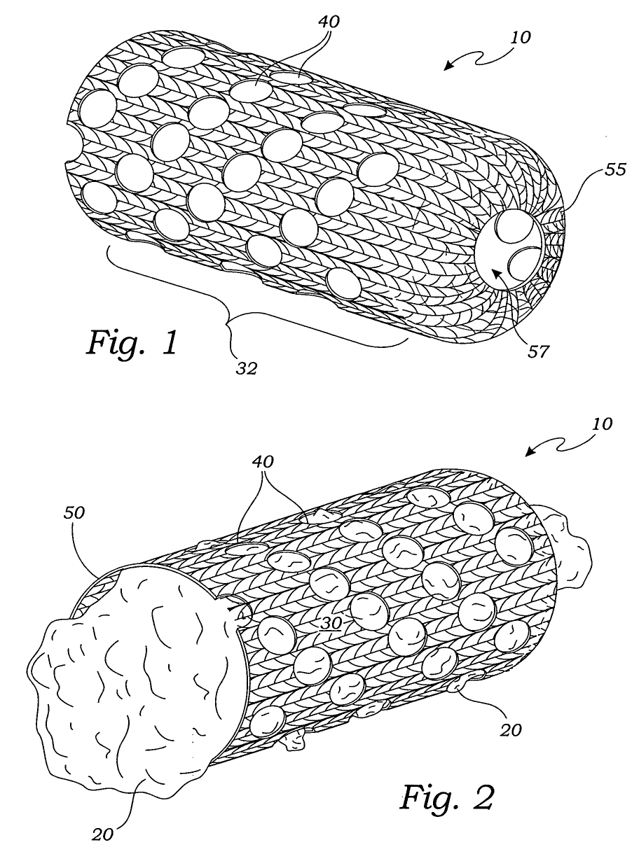

FIGS. 3 and 4 are side elevational view thereof.

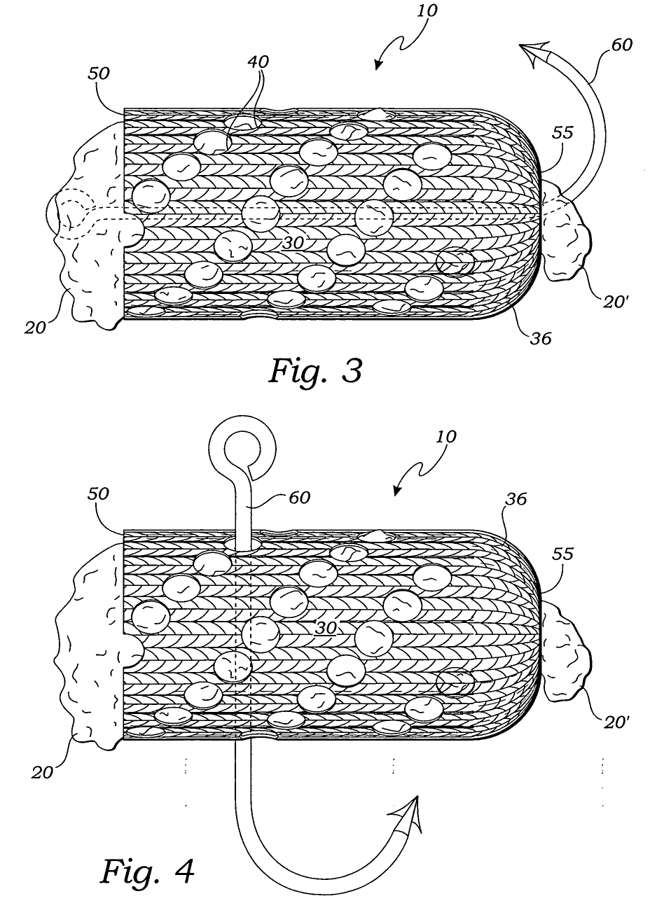

### DETAILED DESCRIPTION OF THE INVENTION

The above described drawing figures illustrate the present disclosure in at least one of its preferred, best mode embodiments, which is further defined in detail in the following description. Those having ordinary skill in the art may be able to make alterations and modifications in the present apparatus without departing from its spirit and scope. Therefore, it must be understood that the illustrated embodiments have been set forth only for the purposes of example and that they should not be taken as limiting the scope of the disclosed embodiments as defined in the following.

In a preferred embodiment, a cage 10 engages a fishing bait 20. The cage 20 is formed of a dried and compressed plant matter fabric 30 of a thickness not greater than approximately 0.060 inches and more preferably between 0.020 and 0.032 inches thick. The plant matter fabric 30 may be of seaweed, kelp or any water borne plant species so that it does not appear or taste alien to fish species. Alternatively, the plant matter fabric 30 may be of a non-water borne plant species or of a fabric made from a plant derivative cloth such as cotton, flax, hemp or wool. The fabric 30 is fashioned by compressing the plant or plant derived materials into a dried and flat form imparting an adequate cohesive strength as a first step. Secondly, the fabric 30 is punched or otherwise punctured as desired. Finally, the perforated fabric 30 is formed into a final shape about a mandrel (not shown), for instance, with edges pressed together to form seams having cohesiveness to form a structure strong enough to encompass and enclose and support a flexible and fragile bait material. The cage 10 is then generally flattened for compact storage, packaging and shipping. In use, the cage 10 is opened as one might open an envelope, a fishing bait 20 is inserted into the cage 10 with a portion of the bait 20 preferably extending from each end of the cage 10 and the bait 20 is then secured within the cage by inserting a fishing hook 60 through the cage and bait.

Preferably, the plant matter fabric provides a first portion 32 having plural perforations such as holes 40, wherein the perforations comprise at least 50% of a surface area of the first portion 32. Alternately, the perforations may comprise slits which tend to stretch into an open state when the bait 20 is placed within the cage 10. In fact, the perforations may be of any type and may vary in size and distribution and still perform within the scope of the present disclosure, i.e., to provide enough exposure from the exterior of the cage 10, of the bait 20. The cage 10 forms an open first end 50 for passing, e.g., inserting, the fishing bait into the cage 10.

Preferably, a second end 55, in opposition to the first end 50, provides a hole 57, larger than the holes 40, in the fabric 30 for extending a part 20′ of the fishing bait 20 outwardly therefrom. The second end 55 preferably provides a second portion 36 of the fabric 30 that is without perforations to assure added strength to the cage 10 especially around the hole 57. Preferably, the cage 10 assumes a cylindrical shape so as to provide an unobstructed space to receive the bait 20, and preferably, the hole 57 is axially centered so as to best receive a portion of the bait that will extend through the hole 57 to better lure a fish to accept the bait.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A fishing bait holding apparatus comprising: a cage formed of a dried and compressed plant matter fabric of a thickness not greater than approximately 0.060 inches for enclosing a fishing bait.

2. The apparatus of claim 1 wherein the plant matter fabric provides a first portion having plural perforations therethrough.

3. The apparatus of claim 2 wherein the perforations comprise at least 50% of a surface area of the first portion.

4. The apparatus of claim 1 wherein the cage forms an open first end for inserting the fishing bait into the cage.

5. The apparatus of claim 4 wherein a second end of the cage, in opposition to the first end, provides a hole in the fabric for extending a part of the fishing bait outwardly therefrom.

6. The apparatus of claim 5 wherein the second end provides a second portion of the fabric without perforations.

7. The apparatus of claim 5 whereby the cage is cylindrical in shape and the hole is axially centered.

8. An fishing apparatus comprising: a cage enclosing a fishing bait, the cage formed of a dried and compressed plant matter fabric of a thickness not greater than approximately 0.060.

9. The apparatus of claim 8 wherein the plant matter fabric provides a first portion having plural perforations therethrough.

10. The apparatus of claim 9 wherein the perforations comprise at least 50% of a surface area of the first portion.

11. The apparatus of claim 8 wherein the cage forms an open first end for inserting the fishing bait into the cage.

12. The apparatus of claim 11 wherein a second end of the cage, in opposition to the first end, provides a hole in the fabric for extending a part of the fishing bait outwardly therefrom.

13. The apparatus of claim 12 wherein the second end provides a second portion of the fabric without perforations.

14. The apparatus of claim 12 whereby the cage is cylindrical in shape and the hole is axially centered.

15. The apparatus of claim 8 further comprising a fishing hook extending laterally through the cage and fishing bait for securing the fishing bait within the cage.

16. The apparatus of claim 15 wherein the fishing hook penetrates the cage laterally.

17. The apparatus of claim 15 wherein the fishing hook penetrates the cage axially.
